(19) United States
(12) Patent Application Publication
(10) Pub. No.: US 2026/0095773 A1
(43) Pub. Date: Apr. 2, 2026

(54) WIRELESS BASE STATION INSTALLATION BASED ON DEVICE SPEED

(71) Applicant: Charter Communications Operating, LLC, St. Louis, MO (US)

(72) Inventor: Pareshkumar Panchal, Highlands Ranch, CO (US)

(21) Appl. No.: 18/899,401

(22) Filed: Sep. 27, 2024

(51) Int. Cl. H04W 16/18

(52) U.S. Cl. CPC H04W 16/18

(57) ABSTRACT

A communication management resource receives wireless service usage information indicating travel speeds of multiple communication devices using a first wireless network in a geographical region to access a remote network. The communication management resource further receives a metric indicating wireless services to provide in the geographical region via a second wireless network. Based on the travel speeds of the multiple communication devices and the metric, the communication management resource produces a wireless base station installation plan to install the second wireless network.

### BACKGROUND

Conventional wireless technology has been used for many years to connect wireless devices such as phones, laptops, etc., to a landline network and other wireless networks. Today, such wireless networks support many different types of connection services and uses cases such as voice communications, cellular communications, high-speed data services, Wi-Fi™ connectivity, and so on.

Cellular networks typically include a land area that has been divided into so-called cellular regions. A single base station typically resides in each cell. Often, the base station is connected to a landline network and supports communication with one or more wireless subscribers operating in a region covered by the cell. Accordingly, a wireless subscriber operating a cell phone in the cell is able to communicate with or have access to a landline network and remote network via a wireless link between the subscriber and a base station.

In certain instances, each of multiple wireless network service providers install wireless base stations in a respective network environment enabling corresponding users to potentially connect to different wireless networks. For example, an operator of a respective mobile communication device may subscribe to use of multiple different networks including a first wireless network provided by a first wireless network service provider and a second network provided by a second wireless network service provider. In such an instance, the communication device is able to connect to either the first wireless network or the second wireless network to access a remote network such as the Internet or other target destination.

### BRIEF DESCRIPTION OF EXAMPLES

This disclosure includes the observation that, in a hybrid wireless network where two network operators A (visitor network) and B (home network) provide wireless services, it is desirable to install wireless access points at appropriate locations to provide wireless services. For example, many subscribers may use wireless services while traveling on respective roads or highways. In such an instance, a respective service provider may wish to install multiple wireless access points to support wireless connectivity during conditions in which respective users and corresponding communication devices are moving. It is noted that spacing between wireless access points is typically required to be smaller when implementing higher wireless frequencies provide wireless services. It is noted that handoffs from the operator A network to the operator B network may be undesirable unless it is necessary to maintain a respective wireless communication link between the communication device and a corresponding remote network.

To provide better use of wireless resources in the network environment, techniques as discussed herein provide improved implementation of multiple networks residing in the same geographical region to provide wireless services to respective wireless communication devices.

More specifically, as discussed herein, in furtherance of efficiently installing wireless access points in a network environment, a communication management resource receives wireless service usage information indicating travel speeds of multiple communication devices in a geographical region. The communication management resource also receives a metric indicating wireless services to provide in the geographical region via a second wireless network. Based on the travel speeds of the multiple communication devices and the metric, the communication management resource produces one or more wireless base station (a.k.a., wireless access point) installation plan in which to install the second wireless network.

The metric used to control installation of one or more wireless access points in the second wireless network can be any suitable information. In a further example, the metric indicating the wireless services to provide to a geographical region may be a minimum threshold number of bits to communicate from the second wireless network in the geographical region. In another example, the metric may be time value indicating a minimum time in which a respective communication device traveling through the geographical region along a pathway must be provided continuous wireless connectivity with the second wireless network without being handed off to the first wireless network.

In addition to receiving the metric or other suitable criteria to control installation of the second wireless network, the communication management resource can be configured to receive throughput information (such as spectral efficiency information) indicating a magnitude of wireless information that can be conveyed over available wireless spectrum in the geographical region. Based on a minimum threshold number of bits and/or the wireless throughput metric, the communication management resource produces the wireless base station installation plan. Installation of wireless base stations associated with a wireless base station installation plan of second wireless network may depend upon whether a proposed sequence of base stations in the geographical region are able to provide continuous (without a handoff to the first wireless network) wireless services for a typical communication device traveling through the geographical region.

In further examples, the first wireless network as discussed herein can be configured to include first wireless base stations operative to provide wireless connectivity to multiple communication devices traveling through the geographical region. Generation of the wireless base station installation plan may include proposing installation of second wireless base stations in the second wireless network at different locations in the geographical region supported by the first wireless network. Thus, the first wireless network may provide backup wireless connectivity during conditions in which there are wireless coverage voids in the second wireless network.

In still further examples, when producing the wireless base station installation plan, the communication management resource or other suitable entity can be configured to assign speed values to different segments of a travel path in the geographical region based on detected travel speeds of multiple communication devices (or dwell times) passing along the travel path through the geographical region as indicated by the wireless service usage information or other suitable information. The communication management resource can be configured to further determine how many new wireless base stations to install in the second wireless network to provide wireless connectivity to the multiple communication devices traveling along the pathway depending upon the metric and the speed values assigned to the different segments of the travel path. In one example, the determined number of new wireless base stations in the second wireless network is configured to provide contiguous wireless coverage through the different segments of the travel path so that the communication devices do not need to hand off to the first wireless network.

Yet further, note that the speed values assigned to the different portions of the travel path may include a first speed value and a second speed value. A first segment of the travel path may be assigned the first speed value. A second segment of the travel path may be assigned the second speed value.

Note further that the wireless networks can be configured to support wireless connectivity using different wireless channels. For example, the first wireless network can be configured to support wireless communications using one or more first wireless channels. The second wireless network can be configured to support wireless communications using one or more second wireless channels. The one or more first wireless channels may be greater in magnitude than a magnitude of the one or more second wireless channels.

The wireless service usage information (indicating a degree to which wireless services are needed along the travel pathway) as discussed herein can be generated and/or received from any suitable resource. In one example, the communication management resource receives the wireless service usage information from a first wireless network service provider operating the first wireless network in the geographical region. The first wireless network can be configured to monitor the travel speeds of the multiple communication devices and produce corresponding wireless service usage information.

Yet further, as previously discussed, the first wireless network can be configured to support one or more first wireless carrier frequencies. Locations of installing wireless base stations in the second wireless network may be based on implementing one or more second wireless carrier frequencies. The one or more second wireless carrier frequencies may be greater in magnitude than the one or more first wireless carrier frequencies. In such an instance, implementation of second wireless base stations in the second wireless network (supporting the one or more higher second wireless carrier frequencies) may require shorter spacings between respective wireless base stations than spacing of wireless base stations (supporting the one or more lower first wireless carrier frequencies) in the first network.

Yet further examples of the communication manager resource or other suitable entity producing the wireless base station installation plan as discussed herein include the communication management resource or other suitable entity proposing spacing of new wireless base stations in the wireless base station installation plan associated with the second wireless network. The spacing of the new wireless base stations in the second wireless network may be selected such that the first wireless network provides the wireless services as indicated by the metric or other implementation criteria.

These and other examples are further discussed herein below.

Note that the examples as discussed herein are useful over conventional techniques. For example, the communication management resource as discussed herein generates wireless base station installation information proposing wireless base station installation in the second wireless network at appropriate spacings and in sufficient number in order to provide a sequence of contiguous (overlapping) regions of wireless coverage. The communication management resource can be configured to use one or more parameters such as spectral efficiency along a respective travel pathway, typical speed of communication devices along the travel pathway, metric indicating a threshold wireless services to provide in the second wireless network, etc., to propose installation of a corresponding threshold number of wireless base stations in the geographical (supporting the sequence of contiguous regions of wireless coverage) in order to prevent excessive handoffs and support efficient use of wireless channels.

Note further that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable hardware storage on which software instructions are encoded for subsequent execution. The computer-readable storage hardware for storing instructions may be configured as a non-transitory computer-readable storage medium. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on computer-readable storage hardware such as a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example herein includes computer-readable storage hardware and/or system having instructions stored thereon. The instructions, when executed by the computer processor hardware, cause the computer processor hardware (such as one or more co-located or disparately processor devices or hardware) to: receive wireless service usage information indicating travel speeds of multiple communication devices in a geographical region; receive a metric indicating wireless services to provide in the geographical region via a second wireless network; and based on the travel speeds of the multiple communication devices and the metric, produce a wireless base station installation plan to install the second wireless network.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity via efficient implementation of a second wireless network and corresponding base stations to provide contiguous wireless coverage in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network environment including a communication management resource and multiple wireless base stations associated with a wireless network service provider supporting wireless communications as discussed herein.

FIG. 2 is an example diagram illustrating a method of generating wireless base station installation information via a communication management resource as discussed herein.

FIG. 3 is an example diagram illustrating dwell time associated with communication devices for different path lengths at different travel speeds as discussed herein.

FIG. 4 is an example diagram illustrating travel times versus device speed as discussed herein.

FIG. 5 is an example diagram illustrating required spectral efficiency at different travel speeds as discussed herein.

FIG. 6 is an example diagram illustrating device speed versus spectral efficiency as discussed herein.

FIG. 7 is an example diagram illustrating device speed ranges and traffic offload percentage from a second wireless network to a first wireless network as discussed herein.

FIG. 8 is an example diagram illustrating a geographical region and corresponding locations of multiple wireless base stations associated with a first wireless network as discussed herein.

FIG. 9 is an example diagram illustrating analysis of subregions for installing wireless base stations and corresponding regions of wireless coverage associated with a second wireless network as discussed herein.

FIG. 10 is an example diagram illustrating example computer hardware and software (such as executable instructions) operable to execute operations as discussed herein.

FIG. 11 is an example diagram illustrating a method as discussed herein.

The foregoing and other objects, features, and advantages of the invention (as described in the following examples) will be apparent from the following more particular description of preferred implementations herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

In one example as discussed herein, in furtherance of efficiently installing wireless access points in a network environment, a communication management resource as discussed herein receives wireless service usage information indicating travel speeds of multiple communication devices potentially using a first wireless network in a geographical region to access a remote network. The communication management resource also receives a metric or installation criteria indicating wireless services to provide in the geographical region via a second wireless network. Based on the travel speeds of the multiple communication devices and the metric (such as installation criteria), the communication management resource produces a wireless base station installation plan in which to install respective wireless base stations in the second wireless network.

Note that the first wireless network in the geographical region may provide traveling communication devices or stationary communication devices wireless access to a remote network. As previously discussed, it may be desirable to implement one or more wireless base stations associated with a second wireless network in the geographical region such that the communication devices in the geographical region have an option of wirelessly connecting to a remote network through either the first wireless network or the second wireless network.

As discussed herein, it may be desirable to implement a sequence of multiple wireless base stations along a respective pathway only if continuous wireless coverage (or wireless service) above a threshold can be provided by for a typical communication device traveling on the pathway without the communication device needing to perform a handoff from the second wireless network to the first wireless network. More specifically, the metric for installation criteria as previously discussed may indicate a minimum threshold amount of data to be supported by the second wireless network for devices traveling along the pathway when the device is connected to the second wireless network. Based on evaluation of one or more parameters such as spectral efficiency, typical device travel speeds of communication devices long the respective travel path, the metric for installation criteria indicating a threshold level, etc., a communication management resource generates one or more wireless base station installation plans.

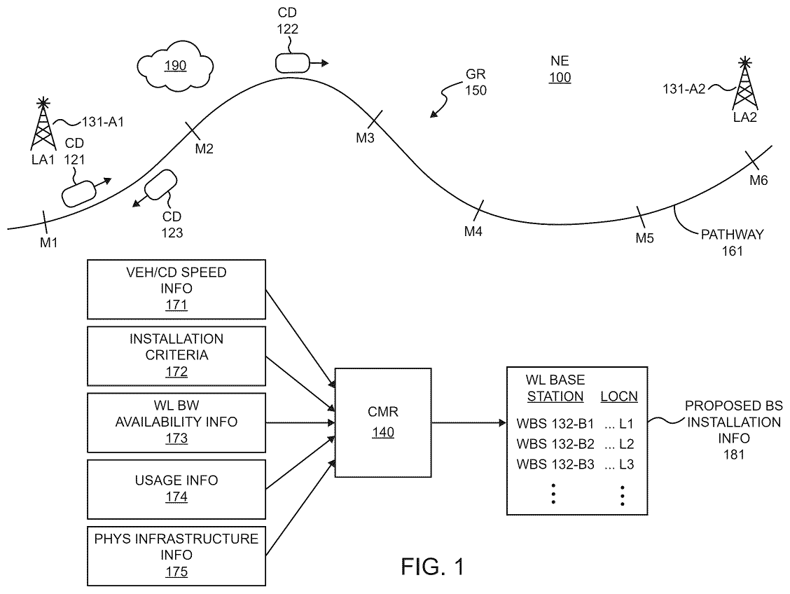

Now, with reference to the drawings, FIG. 1 is an example diagram illustrating a wireless network environment and implementation of the communication management resource to produce wireless base station installation information as discussed herein.

As shown in FIG. 1, the network environment 100 includes multiple wireless base stations 131-A such as including 131-A1, 131-A2, etc., implemented by a first wireless network service provider A providing wireless services to one or more communication devices 121, 122, 123, etc., traveling along the pathway 161 in the geographical region 150 of network environment 100.

It is further shown that the pathway 161 is divided into different segments such as a first pathway segment S1 disposed between the location M1 and the location M2 of the pathway 161; a second pathway segment S2 disposed between the location M2 and the location M3 of the pathway 161; a third pathway segment disposed between the location M3 and the location M4 of the pathway 161; a fourth pathway segment disposed between the location M4 and the location M5 of the pathway 161; and so on.

Further in this example, note that the first wireless network service provider A can be configured to operate the wireless base stations 131-A (such as wireless base stations 131-A1, 131-A2, etc.) at a lower frequency such as less than 3 gigahertz or other suitable carrier frequency to provide longer-range wireless coverage. Based on operation of the wireless base stations 131-A in the first wireless network at the lower frequency such as less than 3 GHz reduces the number of wireless base stations that need to be installed in the network environment 100 to provide wireless services to the respective communication devices 121, 122, 123, etc. In other words, each wireless base station 131-A in the first wireless network can be configured to provide a region of wireless coverage having a radius of around 500-2000 meters. In such an instance, a region of wireless coverage provided by a respective wireless base station in the first wireless network is approximately a diameter of around 2000 to 3000 meters. The distance between the wireless base station 131-A1 at location LA1 and the wireless base station 131-A2 at location LA2 may be around 2000 to 3000 meters.

In another example, each wireless base station implemented in the first wireless network (wireless network service provider A) provides a wireless signal propagation range of approximately 1500 meters or other suitable amount. This means that the edge of the region of wireless coverage associated with each of the wireless base stations 131-A is around 1200 meters or other suitable distance depending on the wireless frequency used.

As further discussed herein, a wireless network service provider B may contemplate installation of one or more wireless base stations to provide wireless connectivity to the communication devices traveling through the network environment 100 and corresponding geographical region 150. Installation of the second wireless network and corresponding wireless base stations as discussed herein provides the communication devices 121, 122, 123, etc., or other communication devices traveling along the pathway 161 another wireless network in which to access the remote network 190. The second wireless network service provider B may implement the second wireless network as a so-called small cell network, where each of the wireless base stations implemented in the second wireless network is operated at a higher frequency than 3.0 GHz. In such an instance, the second wireless network wirelessly transmitting at the lower frequency supports propagation radius of around 200-300 meters or other suitable distance depending upon on antenna height, wireless transmit power, and other factors. Accordingly, many more wireless base stations are required to implement the second wireless network. It is desirable to install wireless base stations in the geographical region 150 when there is a sufficient density of communication devices requiring continuous (uninterrupted) wireless connectivity to the remote network 190.

As further discussed herein, the wireless network service provider B or other suitable entity can be configured to implement communication management resource 140 to evaluate multiple parameters (installation criteria) associated with the network environment 100 for possible installation of one or more wireless base stations to support communication devices traveling along the pathway 161. The parameters available to the communication management resource 140 may include vehicle/communication device speed information 171, threshold (installation criteria) information 172, wireless bandwidth availability information 173, communication device usage information 174, physical infrastructure availability information 175, etc.

The parameters such as vehicle/communication device speed information 171, threshold information 172, wireless bandwidth availability information 173, communication device usage information 174, physical infrastructure availability information 175, etc., available to the communication management resource 140 enables the communication management resource 140 to determine whether or not to install a sequence of corresponding wireless base stations along the different segments along the pathway 161.

In this example, as its name suggests, the vehicle/communication device speed information 171 indicates historical travel speeds of vehicles and/or corresponding communication devices in those vehicles traveling along the different segments of the pathway 161.

The installation criteria 172 (such as including metrics are threshold information) can be configured to include one or more metric for use as a baseline to determine whether or not to install one or more wireless base stations along the different segments of the pathway 161.

As its name suggests, the wireless bandwidth availability information 173 indicates what wireless bandwidth (such as including one or more wireless channels) is available along the different segments of the pathway 161.

As its name suggests, the communication device usage information 174 indicates a degree or amount that each of the different communication devices uses wireless services to access the remote network 190 while those communication devices are at the different segments of the pathway 161.

As its name suggests, the physical infrastructure availability information 175 indicates the different physical infrastructure (such as aerial strands, telephone poles, network nodes, or any network assets, etc.) available along the pathway 161 to support installation of a respective wireless base station by the wireless network service provider B.

As further shown, the communication management resource 140 uses any of the received information such as vehicle speed information 171, installation criteria 172, wireless bandwidth availability information 173, communication device usage information 174, physical infrastructure availability information 175, etc., as a basis in which to produce a respective wireless base station installation information 181 indicating where to install one or more new wireless base stations providing wireless services to the communication devices traveling along the pathway 161.

The communication management resource 140 can be configured to evaluate one or more parameters such as device speed and data usage at different segments of the pathway 161 to determine where to deploy one or more small cell wireless base stations associated with the wireless network service provider B.

In a more specific example, this disclosure includes a method and corresponding hardware to evaluate one or more parameters such as spectral efficiency, vehicle speed, wireless channel availability, expected vehicle traffic and corresponding communication device usage, installation criteria, etc., to determine one or more locations in which to install respective wireless base stations associated with the second wireless network provided by the wireless network service provider B. It is desirable that the second wireless network provides contiguous wireless coverage along the travel pathway 161 to reduce the need to hand off a respective communication device to the first wireless network because the second wireless network does not provide wireless connectivity.

In further examples, as previously discussed, the wireless network service provider A has deployed multiple base stations 131-A1, 131-A2, etc. Additionally, assume that the wireless network service provider B (associated with the second wireless network) has an agreement with wireless network service provider A (associated with the first wireless network) that the second wireless networking and corresponding wireless base stations are to provide wireless connectivity to communication devices when the second wireless network provides better signal strength or wireless coverage and/or network quality to the communication devices traveling along the pathway 161. Since wireless network service provider A implements a macro cell network as previously discussed, the first wireless network typically provides a higher cell coverage radius per wireless base station compared to wireless network service provider B providing wireless base stations having a smaller wireless coverage radius.

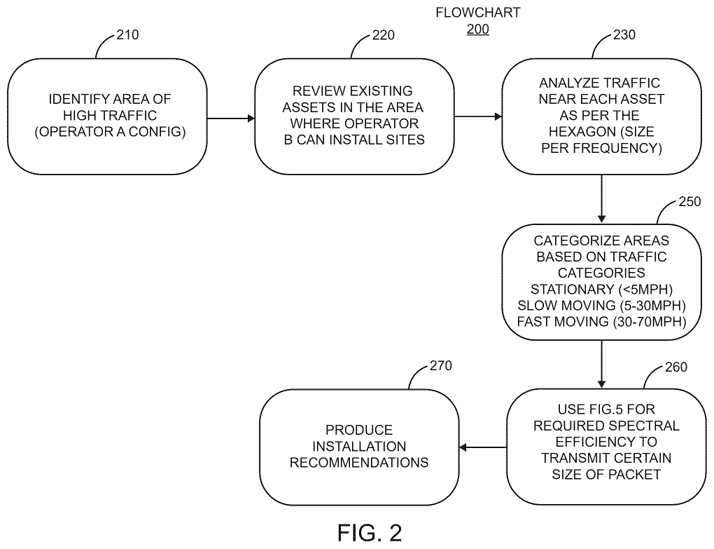

FIG. 2 is an example diagram illustrating a method of generating wireless base station installation information as discussed herein.

In this example, the communication management resource 140 implements the flowchart 200 (method) to produce a respective wireless base station installation plan 181 based on the received information such as speed information 171, installation criteria 172, wireless bandwidth availability information 173, wireless network usage information 174, etc.

More specifically, in processing operation 210, the communication management resource 140 or other suitable entity uses the usage information 174 to identify areas of high vehicle traffic and high wireless network usage along the corresponding pathway 161. The locations of high density of traffic along the pathway 161 are most desirable places in which to install the wireless base stations associated with the second wireless network.

In processing operation 220, the communication management resource 140 reviews the existing available assets (such as telephone poles or other structure to install a respective wireless base station, wireless network cables supporting connectivity to the remote network 190, etc.) in the geographical region 150 where the wireless network service provider B wishes to install respective wireless base stations to support wireless connectivity to a corresponding communication devices traveling along the pathway 161.

In processing operation 230, the communication management resource 140 analyzes the vehicle traffic (such as based on the vehicle/communication device information 171) and corresponding communication device usage information (such as based on usage information 174) near the different available installation locations (such as indicated by the infrastructure information 175) to determine best candidate locations which to install a respective wireless base station associated with the second wireless network.

In processing operation 250, the communication management resource categorizes different areas based on traffic categories such as stationary vehicle traffic or stationary mobile communication devices traveling less than my 5 miles per hour; slow-moving vehicles such as between 5 and 30 miles an hour; and fast moving vehicle such as those traveling between 30 miles per hour and 70 miles hour. Any number of speed classes can be used to keep track of speed of communication devices traveling along the different segments of the pathway 161.

In processing operation 260, the communication management resource 140 uses the required spectral efficiency to determine a magnitude of data of a particular size such as 500 megabytes.

In processing operation 270, the communication management resource 140 or other suitable entity produces the base station installation plan 181 to indicate one or more candidate installation locations for potentially installing respective wireless base stations associated with the second wireless network to provide wireless services to communication devices traveling along the pathway 161. As further discussed herein, the proposal of the locations of the wireless base stations in the second wireless network B may vary depending on a candidate sequence of multiple wireless base stations able to provide continuous wireless service above a threshold level without the respective communication device traveling along the pathway 161 needing to perform a handoff to the first wireless network. In other words, if the threshold metric or criteria information to install the sequence of wireless base stations is 500 mega bits, then the proposed sequence of wireless base stations associated with the second wireless network must be able to provide a continuous session of wirelessly conveying the 500 mega bits in a to the communication device traveling the pathway 161 without the communication device having to hand off to the first wireless network.

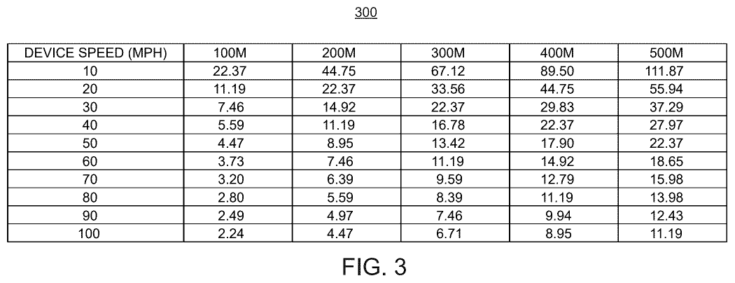

FIG. 3 is an example diagram illustrating dwell time associated with communication devices for different travel speeds as discussed herein.

In this example, the chart 300 in FIG. 3 indicates respective dwell times associated with vehicles and corresponding communication devices traveling at different travel speeds for different path distances. As per the communication device speed, the chart 300 shows time in seconds required to cover 100 meter to 500 meter travel distances based on velocity (speed)=distance/time.

For example, at 10 miles per hour, a respective dwell time of a moving vehicle and corresponding mobile communication device is 22.37 seconds in a 100 meter length travel path; at 10 miles per hour, a respective dwell time of a moving vehicle and corresponding mobile communication device is 44.75 seconds in a 200 meter length travel path; at 10 miles per hour, a respective dwell time of a moving vehicle and corresponding mobile communication device is 67.12 seconds in a 300 meter length travel path; and so on.

At 20 miles per hour, a respective dwell time of a moving vehicle and corresponding mobile communication device is 11.19 seconds in a 100 meter length travel path; at 20 miles per hour, a respective dwell time of a moving vehicle and corresponding mobile communication device is 22.37 seconds in a 200 meter length travel path; at 20 miles per hour, a respective dwell time of a moving vehicle and corresponding mobile communication device is 33.56 seconds in a 300 meter length travel path; and so on.

At 30 miles per hour, a respective dwell time of a moving vehicle and corresponding mobile communication device is 7.46 seconds in a 100 meter length travel path; at 30 miles per hour, a respective dwell time of a moving vehicle and corresponding mobile communication device is 14.92 seconds in a 200 meter length travel path; at 30 miles per hour, a respective dwell time of a moving vehicle and corresponding mobile communication device is 22.37 seconds in a 300 meter length travel path; and so on.

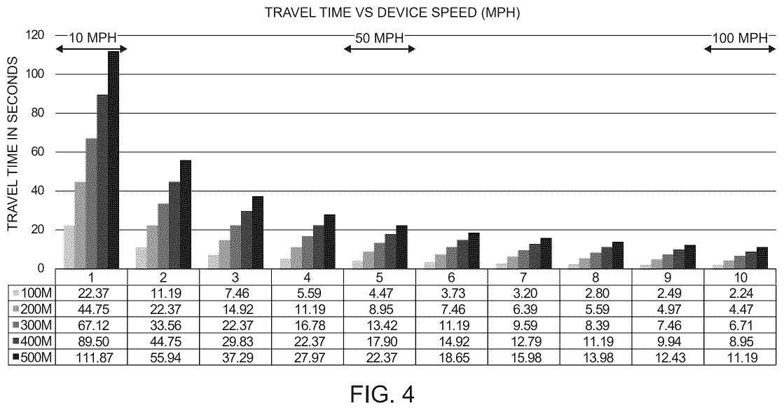

FIG. 4 is an example diagram illustrating travel times versus device speed as discussed herein.

As shown in graph 400, a dwell time of a communication device and corresponding vehicle (the communication device being in the vehicle) within a segment of the pathway 161 varies depending upon the speed of the vehicle as previously discussed.

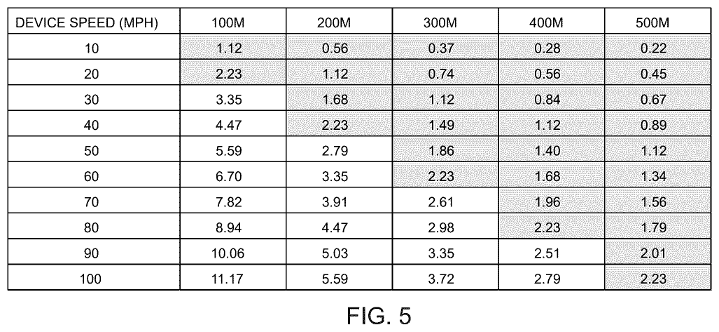

FIG. 5 is an example diagram illustrating required spectral efficiency at different travel speeds as discussed herein.

In this example, spectral efficiency is defined as data in bits/time in seconds/bandwidth in Hz.

For a given radio channel bandwidth of 20 MHz (megahertz), with a device speed of 10 mph (miles per hour), the time needed to travel a 100 meter is 22.37 seconds.

For a given SubCarrier (SC) spacing 15 KHz (kilohertz), with the 20 MHz channel bandwidth, there will be 106 PRBs (Physical Resource Blocks).

Each PRB will have 12 sub carriers and each subcarrier will have 14 symbols per sub frame of 1 ms (millisecond). The total available symbols per second=Number of PRBs×number of SC×number of symbols per millisecond×1000=106×12×14×1000=17,808,000 symbols/second for the 20 megahertz channel.

If we assume cell edge condition for interference, we can have QPSK (Quadrature Phase Shift Keying) modulation which can provide 2 bits/symbol efficiency.

$$Total bits / second = 17 , 808 , 000 symbols / second \times 2 bits / symbol = 35.616 Mbps ( megabits per second ) .$$

Assuming a 15% signaling overhead (where 15 percent of the available 20 megahertz bandwidth is used support management of the wireless communication link), a single wireless channel 20 megahertz provides a 30.27 Mbps data rate (35.616×0.85). In such an instance, at a transmission rate of 30.27 Mbps via a 20 MHz bandwidth, this provides a 1.5 bit/second/hertz spectral efficiency at a respective cell edge.

For a given time requirement for distance travel, the chart 500 in FIG. 5 indicates effective spectral efficiency needed to provide a transfer 500 Mb (a.k.a., megabits) of data without having to handoff a respective communication device traveling long pathway 161 from the second wireless network to the first wireless network.

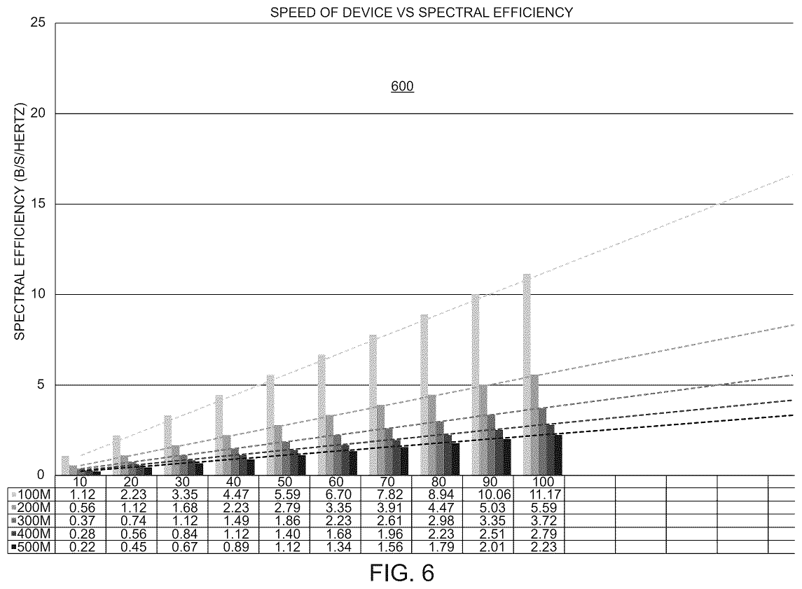

FIG. 6 is an example diagram illustrating device speed versus spectral efficiency as discussed herein.

Typically, achievable spectral efficiency (a.k.a., SE) for wirelessly transmitting data for the above conveyance condition will be approximately 1.5 bits/second/hertz as shown in the calculation above using the available 20 megahertz channel. In such an instance, if we want to consider a traffic data situation, if we provide continuous or contiguous wireless coverage of 500 meters for a small cell in a mobility area for the second wireless network along the pathway 161 (such as roads, highways, streets, pathway, etc.), the wireless network service provider B in corresponding second wireless network will be able to provide wireless service (wireless connectivity of a device traveling on a respective pathway to transfer a 500 Mb packet at 60 mph) vehicle at the needed SE (spectral efficiency) of 1.34 bit/second/hertz (which is <1.5).

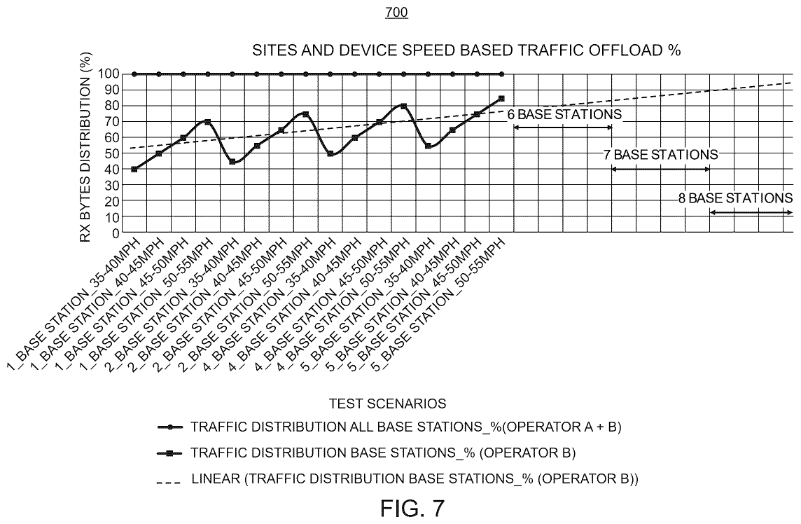

FIG. 7 is an example diagram illustrating device speed ranges and traffic offload percentage as discussed herein.

Graph 700 indicates, for a requirement of contiguous wireless coverage for more than 500 meters along the pathway 161, spectral efficiency of 1.34 b/s/h at a 60 mph speed. If the network support is needed for >60mph, it will be necessary to increase the contiguity of coverage provided by the new wireless base stations associated with the second wireless network. On the other hand, if the second wireless network is unable to provide contiguous wireless coverage via wireless base stations in the second wireless network without a handoff for a minimum of 500 megabits, then the wireless base stations are deployed in the second network. This will save on unnecessary costs of installing wireless base stations in the second wireless network because the communication devices will have to hand off to the.

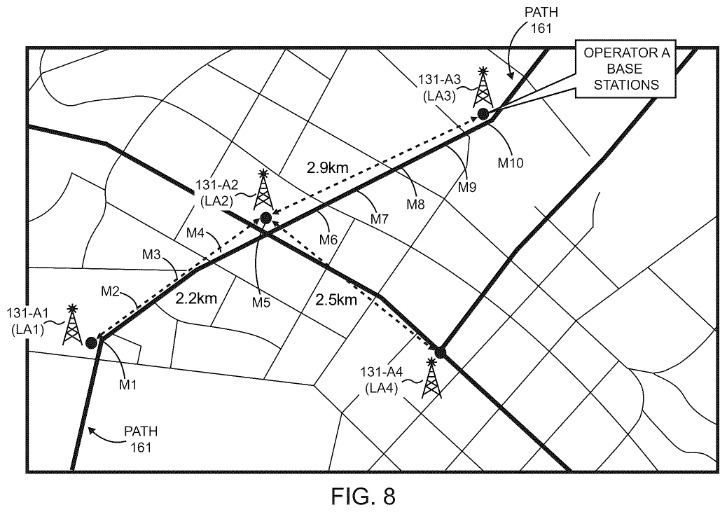

FIG. 8 is an example diagram illustrating locations of multiple wireless base stations associated with a first wireless network as discussed herein.

In this example, the network environment 100 and corresponding first wireless network provided by the wireless network service provider A includes: wireless base station 131-A1 disposed at location LA1 near location M1 of the pathway 161, wireless base station 131-A2 disposed at location LA2 of the pathway 161, wireless base station 131-A3 disposed at location LA3 of the pathway 161, and so on.

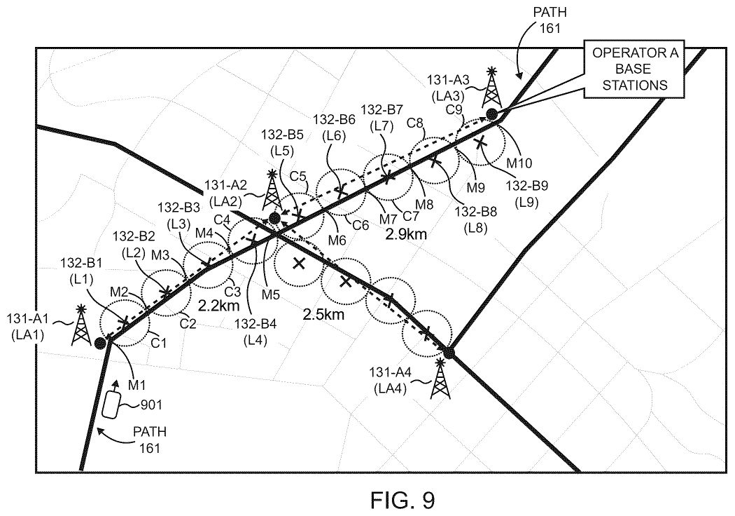

The wireless base station 131-A1 generally provides wireless connectivity to devices disposed between location M1 and location M3 along the pathway 161. The wireless base station 131-A2 provides wireless connectivity to devices disposed between the location M3 and location M7 of the pathway 161, and so on. As further discussed below in FIG. 9, the second wireless network service provider considers implementing a sequence of 2 or more wireless base stations (each wireless base station in the second wireless network having a smaller region of wireless coverage than the region of wireless coverage of wireless base stations in the first wireless network) in order to provide desired wireless services in accordance with corresponding installation criteria and other received information for the given region.

More specifically, FIG. 9 is an example diagram illustrating analysis of different subregions along a pathway for potentially installing wireless base stations associated with a second wireless network as discussed herein.

In this example, the wireless network service provider B considers whether it is desirable to install one or more wireless base stations along the pathway 161 to provide wireless services to its subscribers traveling along the pathway 161. As previously discussed, the communication management resource 140 can be configured to receive wireless service usage information (171, 174) indicating usage and travel speeds of multiple communication devices traveling along the pathway 161 in the geographical region 150. Further, as previously discussed, the first wireless network A includes wireless base station 131-A-1 disposed at location LA1, wireless base station 131-A2 disposed at location LA2, wireless base station 131-A3 disposed that location LA3, wireless base station 131-A4 disposed that location LA4, and so on.

In one example, the communication management resource 140 receives a metric (such as via installation criteria 172 or other suitable information) indicating second wireless services to provide in the geographical region 150 via a second wireless network.

Via received information as previously discussed, the communication management resource 140 determines a typical travel speed associated with each of the different segments along the pathway 161.

For example, via the vehicle/communication device speed information 171, the communication management resource 140 determines that: i) the typical travel speed of communication devices traveling along the segment between the location M1 and the location M2 of the pathway 161 is 30 miles per hour, ii) the typical travel speed of communication devices traveling along the segment of pathway 161 between the location M2 and the location M3 is 30 miles per hour, iii) the typical travel speed of communication devices traveling along the segment of the pathway 161 between the location M3 and the location M4 is 30 miles per hour, iv) the typical travel speed of communication devices traveling along the segment of the pathway 161 between the location M4 and the location M5 is 30 miles per hour. Via the installation criteria 172 such as including threshold information, the communication management resource 140 determines that the second wireless network must provide a minimum of 500 megabits of data to a communication device or each subsequent communication device 901 traveling along the pathway 161 without handing off the corresponding communication device to the first wireless network (such as corresponding wireless base stations 131-A1, 131-A2, etc.).

In such an instance, based on a spacing of 300 meters between each of the locations M1, M2, M3, etc., (such as an approximate diameter of a region of wireless coverage provided by each wireless base station in the second wireless network), the communication management resource 140 considers implementing a respective wireless base station at each of locations L1, L2, L3, L4, etc.

In other words, the region of wireless coverage C1 associated with proposed wireless base station 132-B1 may be a diameter of 300 meters, where the wireless base station 132-B1 is disposed at the center of the region of wireless coverage C1; the region of wireless coverage C2 associated with proposed wireless base station 132-B2 may be a diameter of 300 meters, where the wireless base station 132-B2 is disposed at the center of the region of wireless coverage C2; the region of wireless coverage C3 associated with proposed wireless base station 132-B3 may be a diameter of 300 meters, where the wireless base station 132-B3 is disposed at the center of the region of wireless coverage C3; the region of wireless coverage C4 associated with proposed wireless base station 132-B4 may be a diameter of 300 meters, where the wireless base station 132-B4 is disposed at the center of the region of wireless coverage C4; the region of wireless coverage C5 associated with proposed wireless base station 132-B5 may be a diameter of 300 meters, where the wireless base station 132-B5 is disposed at the center of the region of wireless coverage C5; the region of wireless coverage C6 associated with proposed wireless base station 132-B6 may be a diameter of 300 meters, where the wireless base station 132-B6 is disposed at the center of the region of wireless coverage C6; and so on.

As previously discussed, the proposed sequence of wireless base stations for installation of the second wireless network as indicated by the installation information 181 may include any number of contiguous wireless base stations along the path 161.

Thus, a proposed installation of a wireless base station associated with the second wireless network at the location L1 provides a region wireless coverage C1; a proposed installation of a wireless base station associated with the second wireless network at the location L2 provides a region wireless coverage C2; a proposed installation of a wireless base station associated with the second wireless network at the location L3 provides a region wireless coverage C3; a proposed installation of a wireless base station associated with the second wireless network at the location L4 provides a region wireless coverage C4; and so on.

In this example, proposed installation of a wireless base station 132-B1 provides wireless services to communication devices traveling in the segment S1 between M1 and M2; proposed installation of a wireless base station 132-B2 provides wireless services to communication devices traveling in the segment S2 between M2 and M3; proposed installation of a wireless base station 132-B3 provides wireless services to communication devices traveling in the segment S3 between M3 and M4; proposed installation of a wireless base station 132-B4 provides wireless services to communication devices traveling in the segment S4 between M4 and M5; etc.

Assume that the spectral efficiency associated with transmitting data bits from each of the proposed wireless base stations is 30.27 Mbps as previously discussed. For a communication session between the second wireless network and a first communication device 901 traveling along the pathway 161, assuming that the metric in the installation criteria information 172 indicates a metric or threshold level indicating requirement of transmitting 500 megabits from the second wireless network to the traveling first communication device 901 along the pathway 161 between location M1 and location M5, the communication management resource 140 determines how many wireless base stations or a minimum number of wireless base stations in the second wireless network that need to be implemented to support the threshold level communication session of at least 500 megabits. As previously discussed, the minimum threshold level of 500 megabits transmission may be set to avoid undesirable high-frequency of handoffs between the second wireless network in the first wireless network.

Further in this example, given that the dwell time of the communication device 901 traveling at 30 miles per hour in each segment on the travel pathway 161 between is 22.37 seconds because the average speed for each of the segments S1, S2, S3, etc., is 30 miles per hour, each wireless base station (132-B1, 132-B2, 132-B3, etc.) between M1 and M5 can transmit 677 megabits (22.7 seconds×30.27 Mbps) to the communication device 901 traveling along the pathway 161. In such an instance, the communication management resource 140 can be configured to produce the proposed installation information 181 to indicate that the requirement of transmitting 500 megabits can be achieved by installing a single wireless base station (such as any of the wireless base stations 132-B1 along the pathway 161.

Additionally, note that the minimum requirement (as indicated by the installation criteria 172 or other information) of providing a download of 500 megabits when traveling 30 miles per hour between location M2 and location M5 may be achieved via implementation of at least 3 wireless base stations such as a second sequence of wireless base stations 132-B2, 132-B3, and 132-B4. Further, the minimum requirement of providing a download of 500 megabits when traveling 30 miles per hour between location M1 and location M5 may be achieved via implementation of 4 wireless base stations such as a third sequence of wireless base stations 132-B1, 132-B2, 132-B3, and 132-B4. Thus, the communication management resource 140 can be configured to provide notification of different options of installing sequences of wireless base stations providing contiguous coverage along the pathway 161 without a handoff.

As another example, assume that the spectral efficiency associated with transmitting data bits from each of the proposed wireless base stations is 10 Mbps instead of 30.27 Mbps as previously discussed. To provide a continuous communication session between the second wireless network and a first communication device 901 traveling along the pathway 161 without a handoff the first wireless network, assuming that the metric in the threshold metric information 172 indicates a requirement of transmitting 500 megabits from the second wireless network to the traveling first communication device along the pathway 161 between location M1 and location M5, the communication management resource 140 determines how many wireless base stations need to be implemented to support the minimum communication session threshold level of 500 megabits data without handing off from the second wireless network to the wireless network. Given that the dwell time in each segment is 22.37 seconds because the average speed for each of the segments S1, S2, S, and S4 is 30 miles per hour, each wireless base station between M1 and M9 can transmit 225 megabits to the communication device traveling along the pathway 161. In such an instance, the communication management resource 140 produces the proposed installation information 181 to indicate that the requirement of transmitting 500 megabits can be achieved by installing a sequence of at least 3 contiguous wireless base stations along the pathway 161. In other words, the contiguous wireless base stations as indicated by the proposed installation information 181 may include implementation of at least wireless base station 132-B1 at location L1, wireless base station 132-B2 at location L2, and wireless base station 132-B3 at location L3. Thus, a communication device 901 traveling along the pathway 161 can be provided a service of a minimum 500 megabits when traveling 30 miles per hour between location M1 and location M4 via implementation of at least 3 wireless base stations such as a first sequence of wireless base stations 132-B1, 132-B2, and 132-B3 providing contiguous wireless coverage via wireless coverage C1, wireless coverage C2, and wireless coverage C3.

The proposed installation information 181 may further indicate that a longer sequence of wireless base stations may be used to support the wireless connectivity in accordance with the installation criteria 172. For example, the proposed installation information 181 may indicate that a sequence of wireless base stations 132-B1, 132-B2, and 132-B3 may provide the appropriate wireless services of 500 mega bits of packet data; the proposed installation information 181 may indicate that a sequence of wireless base stations 132-B2, 132-B3, and 132-B4 may provide the appropriate wireless services of 500 Mbps; the proposed installation information 181 may indicate that a sequence of wireless base stations 132-B2, 132-B3, 132-B4, and 132-B5 may provide the appropriate wireless services of 500 Mbps; the proposed installation information 181 may indicate that a sequence of wireless base stations 132-B1, 132-B2, 132-B3, 132-B4, and 132-B5 may provide the appropriate wireless services of 500 mega bits of packet data; and so on.

In one example, the physical infrastructure information 175 may indicate that there is no physical resource available to install a respective wireless base station to support installation of the wireless base station 132-B4 at the segment S4 of the pathway 161 between the location M4 and the location M5. In such an instance, the proposed installation information generated by the communication management resource 140 may indicate that the sequence of wireless base stations including wireless base stations 132-B1, 132-B2, and 132-B3 may provide the appropriate wireless services of 500 mega bits of packet data; the sequence of wireless base stations including wireless base stations 132-B1, 132-B2, and 132-B3 may provide the appropriate wireless services of 500 Mbps; and so on. Thus, the availability of infrastructure may limit the options of installing the wireless base stations.

Note further that installation of one or more wireless base stations in the second wireless network may be contingent on the vehicle/communication device speed information 171 or other information received by the communication management resource 140 indicating that the density of users operating communication devices traveling along the pathway 161 and subscribing to the second wireless network service provider is above a threshold level, making it worthwhile to install the proposed wireless base stations along the pathway 161 as previously discussed.

Thus, based on the travel speeds of the multiple communication devices and the threshold metric for installation criteria 172, the communication management resource 140 can be configured to produce a wireless base station installation plan including many options in which to install the second wireless network. The metric of 500 mega bits of packet data may be a minimum threshold number of bits to communicate from the second wireless network to a communication device in the geographical region during a communication session.

Note that each of the different segments along the pathway 161 can be assigned a different average speed value based upon the typical speeds of corresponding vehicles the travel the pathway 161. For example, based on the vehicle/communication device information 171 or other monitor information, the communication management resource 140 or other suitable entity can be configured to assign a speed value of 30 miles per hour to the first segment S1 between location M1 and location M2 of the pathway 161 indicating that communication devices traveling along the first segment S1 travel at an average speed of 30 miles per hour; communication management resource 140 or other suitable entity can be configured to assign a speed value of 60 miles per hour to the second segment S2 between location M2 and location M3 of the pathway 161 indicating that communication devices traveling along the second segment S2 travel at an average speed of 60 miles per hour; communication management resource 140 or other suitable entity can be configured to assign a speed value of 45 miles per hour to the third segment S3 between location M3 and location M4 of the pathway 161 indicating that communication devices traveling along the segment S3 travel at an average speed of 45 miles per hour; communication management resource 140 or other suitable entity can be configured to assign a speed value of 30 miles per hour to the third segment S4 between location M4 and location M5 indicating that communication devices traveling along the segment S4 travel at an average speed of 30 miles per hour; and so on.

Based on a combination of the average speed assigned to the different segments as well as spectral efficiency (which may be the same or different for each segment) for each of the different segments and metric such as threshold level of 500 megabits or other suitable value, the communication management resource 140 produces the wireless base station installation plan 181 indicating different sequences of contiguous wireless base stations in the second wireless network that are needed to support the 500 megabits transmission of data to a communication device 901 as it travels along the pathway 161.

Accordingly, generation of the wireless base station installation information 181 (such as a base station installation plan for the second wireless network) may include the communication management resource 140: i) based on the travel speeds of the multiple communication devices as indicated by wireless service usage information such as vehicle/communication device information 171 and/or the usage information 174, assigning speed values to different segments of a travel path in the geographical region, and ii) determining a number of contiguous new wireless base stations to potentially install in the second wireless network to provide wireless connectivity (wireless services) to the multiple communication devices traveling along the pathway 161 depending upon the metric (500 megabits for a communication session) and the speed values assigned to the different segments of the travel path 161.

More specifically, assume in this example that the available wireless bandwidth information 173 indicates that the spectral efficiency that each of the segments between location M1 and location M5 is 5 Mbps. In such an instance, a communication device 901 traveling along the pathway 161 has a dwell time of 22.37 seconds in the region of wireless coverage C1 (segment S1 assigned the speed value 30 miles per hour) and is therefore able to receive (5×22.37) 111.8 megabits from the proposed wireless base station 132-B1 while traveling through the first segment S1; the communication device 901 traveling along the pathway 161 has a dwell time of 11.19 seconds in the region of wireless coverage C2 (segment S2 assigned the speed value 60 miles per hour) and is therefore able to receive (5×11.19) 56 megabits from the proposed wireless base station 132-B2 while traveling through the first segment S2; the communication device 901 traveling along the pathway 161 has a dwell time of 16 seconds in the region of wireless coverage C3 (segment S3 assigned the speed value 45 miles per hour) and is therefore able to receive (5×16) 80 megabits from the proposed wireless base station 132-B3 while traveling through the segment S3; the communication device 901 traveling along the pathway 161 has a dwell time of 16 seconds in the region of wireless coverage C3 (segment S3 assigned the speed value 45 miles per hour) and is therefore able to receive (5×16) 80 megabits from the proposed wireless base station 132-B3 while in the segment S3; a communication device 901 traveling along the pathway 161 has a dwell time of 22.37 seconds in the region of wireless coverage C4 (segment S4 assigned the speed value 30 miles per hour) and is therefore able to receive (5×22.37) 111.8 megabits from the proposed wireless base station 132-B4 while in the segment S4.

In these circumstances, the communication management resource can be configured to determine that the sequential combination of wireless base station 132-B1, 132-B2, 132-B3, and 132-B4, collectively provide a download capability of (111.8 megabits plus 56 megabits plus 80 megabits plus 111.8 megabits=359 megabits) do not provide a sufficient level of download capability (such as 500 megabits) during a respective communication session between the communication device 901 and the second wireless network. However, the communication management resource 140 can be configured to further consider proposing an additional installation of a respective wireless base station 132-B5 at the location L5 along the pathway 161 between. The proposed wireless base station 132-B5 provides the region of wireless coverage C5 supporting wireless connectivity of devices (including communication device 901) disposed in the segment S5 between the location M5 and the location M6. Assume that the speed value assigned to the segment S5 is 20 miles per hour. In such an instance, the total time of a respective communication device 901 being present in the segment S5 while traveling along the pathway 161 is 33 seconds. In such an instance, at the spectral efficiency of 5 megabits per second in the region of wireless coverage C5, the proposed wireless base station 132-B5 is able to wirelessly transmit 165 megabits (5 mbps×33 seconds) to the communication device 901. This brings the total download capability of all of the proposed wireless base stations 132-B1, 132-B2, 132-B3, 132-B4, and 132-B5, as being 524 megabits (359 plus 165). In such an instance, installation of a string of wireless base stations 132-B1, 132-B2, 132-B3, 132-B4, and 132-B5, between location M1 and location M6 as being a sufficiently long contiguous base station string such that a respective communication device 901 traveling along the respective segments S1 through S5 would not need to hand off to the first wireless network or wireless base station 131-E to before being able to download 500 megabits from the second wireless network of wireless base stations to the communication device 901.

Thus, the communication management resource 140 and corresponding wireless network service provider B may use the metric of 500 megabits as a basis in which to determine whether or not to install a sequence of wireless base stations. This metric can be increased or decreased as desired. If the metric is lowered to 350 megabits, then the installation of a string of contiguous wireless base stations 132-B1, 132-B2, 132-B3, and 132-B4, between the location M1 and the location M5 in the above example would be sufficient to provide the desired download capability of transmitting data from the second wireless network to the communication device 901 without the communication device 901 having to hand off to the first wireless network.

Thus, the communication management resource 140 can be configured to determine a number of new wireless base stations to install in the second wireless network in order to provide contiguous wireless coverage to a communication device 901 traveling through the different segments of the travel path 161. In other words, via the wireless base station installation plan 181, the communication management resource 140 proposes installation of one or more different sequences of new wireless base stations in the second wireless network, where the proposed sequences of the new wireless base stations are determined to provide desired wireless services (such as wireless download) as continuous wireless services along the path 161 in accordance with the metric (such as 500 megabits).

Further, as previously discussed, the usage information 174 can be used as a basis whether or not to even consider installation of wireless base stations associated with the second wireless network. For example, if it is determined that no subscribers associated with the second wireless network the corresponding second wireless network service provider B travel long the corresponding pathway 161, then the communication management resource 140 can be configured to provide a recommendation not to install any wireless base stations for the second network along the pathway 161.

Note that the usage information 174 may include wireless service usage information generated by the first wireless network service provider A operating the first wireless network in the geographical region 150. In one example, the first wireless network monitors the travel speeds of the multiple communication devices (121, 122, 123, etc.) and produces respective wireless service usage information (usage information 174). Alternatively, note that the usage information 174 you be generated by any suitable resource.

Yet further, as previously discussed, the first wireless network and corresponding wireless base stations 131-A1, 131-A2, 131-A3, etc., can be configured to use a first wireless carrier frequency to communicate with respective communication devices traveling along the pathway 161. As previously discussed, based on the use of the first wireless carrier frequency, the wireless base stations 131-A1, 131-A2, 131-A3, etc., in the first wireless network each provide a greater sized region of wireless coverage) than the propose wireless base stations 132-B associated with the second wireless network (each base station 131-B1, 131-B2, 131-B3, etc., using a second wireless carrier frequency greater magnitude than the first wireless carrier frequency).

Still further, it is noted that the wireless bandwidth availability information 173 may indicate that no wireless channels are available to the second wireless network in every other segment (S2, S4, S6, etc.) such as including: segment S2 of the geographical region 150 between the location M2 and location M3; segment S4 of the geographical region 150 between the location M4 and location M5; and so on. In such an instance, assuming that the segments S1, S3, S6, etc., themselves do not provide the ability to support download of 500 megabits while a respective communication device is present in those corresponding segments, the communication management resource 140 can be configured to indicate that it is undesirable to install any new wireless base stations 132 because there is no sequence of contiguous wireless base stations along the pathway the one that will be able to provide contiguous wireless coverage along the pathway 161 according to the metric of 500 megabits or other installation criteria 172.

Note further that the spectral efficiency associated with each of the segments along the pathway 161 may vary, the availability of wireless bandwidth may vary, etc. The average speed of communication devices traveling along the pathway 161 may also vary. In such an instance, assuming that wireless bandwidth is available along each of the segments along the pathway 161, the communication management 140 can be configured to determine different contiguous sequences of wireless base stations installed along the pathway 161 that are able to provide the download capability of at least 500 megabits without having to hand off the corresponding communication device 901 from the second wireless network to the first wireless network.

As further discussed herein, note that the metric for installation criteria 172 used as a basis for installing a sequence of wireless base stations to provide contiguous wireless coverage in the second wireless network may vary depending on the circumstance. For example, as previously discussed, the installation criteria 172 received by the communication management resource 140 may indicate that criteria for installing a respective sequence of wireless base stations associated with the second wireless network may depend upon simply a pre-specified amount of time that the respective communication device 901 traveling along the pathway must be provided continuous wireless service from the second wireless network without requiring the communication device 901 to hand off to the first wireless network.

More specifically, assume that the installation criteria 172 as discussed herein indicates that a sequence of new wireless base stations associated with the newly installed second wireless network must provide a minimum of 40 seconds of continuous wireless connectivity with the second wireless network (and multiple newly installed wireless base stations providing contiguous wireless coverage) when the communication device 901 travels along the pathway 161 without a respective hand off to the first wireless network. Assume that the segment S1 between location M1 and location M2 of the pathway 161 is assigned a speed value of 30 miles per hour; the segment S2 between location M2 and location M3 of the pathway 161 is assigned a speed value of 30 miles per hour; the segment S3 between location M3 and location M4 of the pathway 161 is assigned a speed value of 60 miles per hour; the segment S3 between location M3 and location M4 of the pathway 161 is assigned a speed value of 60 miles per hour; the segment S4 between location M4 and location M5 of the pathway 161 is assigned a speed value of 60 miles per hour; the segment S5 between location M5 and location M6 of the pathway 161 is assigned a speed value of 60 miles per hour.

In such an instance, the dwell time of the communication device 901 traveling along the pathway 161 in each of the different segments is as follows: the communication device 901 traveling at 30 miles per hour in the segment S1 is present in the segment S1 for 22 seconds; the communication device 901 traveling at 30 miles per hour in the segment S2 is present in the segment S2 for 22 seconds; the communication device 901 traveling at 60 miles per hour in the segment S3 is present in the segment S3 for 11 seconds; the communication device 901 traveling at 60 miles per hour in the segment S4 is present in the segment S4 for 11 seconds; the communication device 901 traveling at 60 miles per hour in the segment S5 is present in the segment S5 for 11 seconds.

As previously discussed, the installation criteria 172 may indicate a desired minimum time of 40 seconds of the second wireless network providing continuous wireless connectivity with the communication device 901. In such an instance, based on the required minimum time of 40 seconds, the communication management resource 140 can be configured to determine that a sequence of wireless base stations including installation of wireless base station 132-B1 at the location L1 (providing 22 seconds of wireless coverage via region of wireless coverage C1) and installation of the wireless base station 132-B2 at location L2 (providing 22 seconds of wireless coverage via region of wireless coverage C2) in combination provides 44 seconds of wireless connectivity without requiring handoff of the communication device 901 to the first wireless network. Thus, the communication management resource can generate the installation information 181 to indicate a potential sequence of 2 wireless base stations including at least wireless base station 132-B1 at the location L1 and installation of the wireless base station 132-B2 at location L2.

Further, the communication management resource 140 can be configured to determine that the dwell time of the communication device 901 in the segment S3 is only 11 seconds. In such an instance, the combination of wireless base station 132-B2 (supporting 22 seconds) and wireless base station 132-B3 (supporting 11 seconds) provides a total connectivity time of 33 seconds. This does not provide total wireless connectivity above the 40 second threshold. In such an instance, the communication management resource 140 is not propose installation of the combination of wireless base station 132-B2 and wireless base station 132-B3 to support the connectivity time of 33 seconds.

However, the communication management resource 140 can be configured to determine that the dwell time of the communication device 901 in the segment S4 and corresponding region of wireless coverage C4 is only 11 seconds. In such an instance, the combination of wireless base station 132-B2 (supporting 22 seconds of wireless connectivity in region of wireless coverage C2) and wireless base station 132-B3 (supporting 11 seconds of wireless connectivity in region of wireless coverage C3) and wireless base station 132-B4 (supporting 11 seconds of wireless connectivity in region of wireless coverage C4) provides a total connectivity time of 44 seconds. This sequence of wireless base stations including wireless base station 132-B2, wireless base station 132-B3, and wireless base station 132-B4 does provide total wireless connectivity above the 40 second threshold as specified by the installation criteria 172. In such an instance, the communication management resource 140 produces the respective installation information 181 indicating this sequence of at least 3 wireless base stations 132-B2, 132-B3, 132-B4, as an option to provide continuous wireless coverage in the segments between location M2 and location M5 to achieve the greater than 40 second wireless connectivity as indicated by the installation criteria 172.

For any sequence of possible wireless base stations that do provide the desired wireless services above a respective threshold level such as 500 megabits or 40 seconds or any other threshold setting as indicated by the installation criteria 172, note further that the communication management resource 140 can be configured to indicate that the minimal sequence of wireless base stations can be extended to include any additional base stations installed in the geographical region 150 to provide continuous wireless support for the longer portion of the pathway 161.

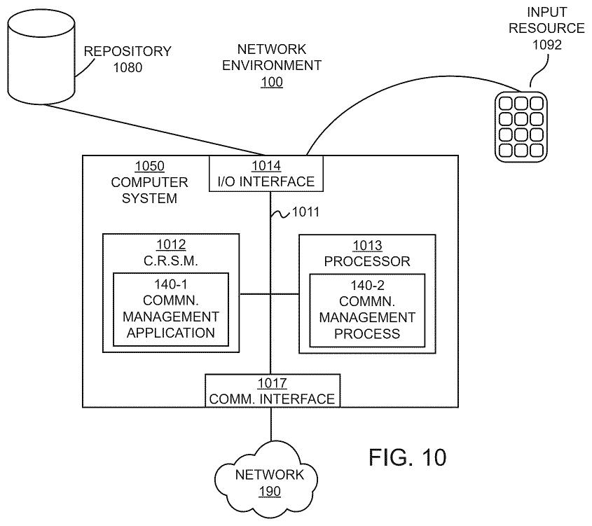

FIG. 10 is an example block diagram of a computer system for implementing any of the operations as discussed herein.

Note that any of the resources (such as communication management resource 140 or other suitable entity) as discussed herein can be configured to include computer processor hardware and/or corresponding executable instructions to carry out the different operations as discussed herein.

For example, as shown, computer system 1050 of the present example includes interconnect 1011 coupling computer readable storage media 1012 such as a non-transitory type of media (which can be any suitable type of hardware storage medium in which digital information can be stored and or retrieved), a processor 1013 (computer processor hardware), I/O interface 1014, and a communications interface 1017.

I/O interface(s) 1014 supports connectivity to repository 1080 and input resource 1092.

Computer readable storage medium 1012 can be any hardware storage device such as memory, optical storage, hard drive, floppy disk, etc. In one example, the computer readable storage medium 1012 is computer readable storage hardware that stores instructions and/or data.

As shown, computer readable storage media 1012 can be encoded with management application 140-1 (e.g., including instructions) in a respective wireless station to carry out any of the operations as discussed herein.

During operation of one example, processor 1013 accesses computer readable storage media 1012 via the use of interconnect 1011 in order to launch, run, execute, interpret or otherwise perform the instructions in management application 140-1 stored on computer readable storage medium 1012. Execution of the management application 140-1 (communication management application) produces management process 140-2 (communication management process) to carry out any of the operations and/or processes as discussed herein.

Those skilled in the art will understand that the computer system 1050 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1050 may reside at any location or can be included in any suitable resource in any network environment to implement functionality as discussed herein.

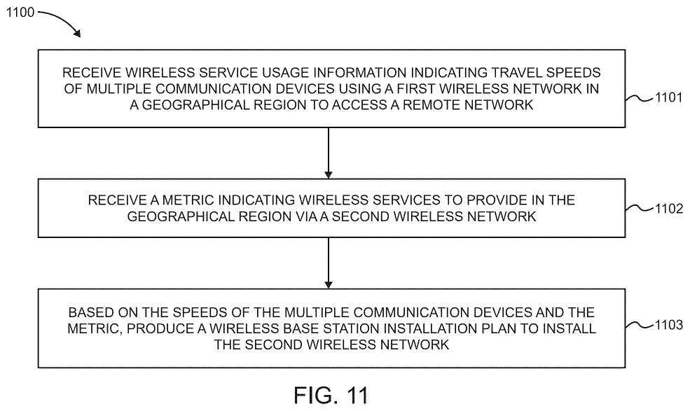

Functionality supported by the different resources will now be discussed via flowchart in FIG. 11. Note that the steps in the flowcharts below can be executed in any suitable order.

FIG. 11 is a flowchart 1100 illustrating an example method according to examples herein. Note that there will be some overlap with respect to concepts as discussed above because the flowchart 1100 captures the general ideas as previously presented.

In processing operation 1101, the communication management resource 140 receives wireless service usage information indicating travel speeds of multiple communication devices using a first wireless network in a geographical region to access a remote network.

In processing operation 1102, the communication management resource receives a metric or installation criteria information indicating attributes of wireless services to be provided by a second wireless network in the geographical region.

In processing operation 1103, based on the travel speeds of the multiple communication devices and the installation criteria, the communication management resource produces a wireless base station installation plan including one or more sequences of contiguous wireless base stations 132 to install the second wireless network to provide the desired uninterrupted wireless services (wireless upload or download).

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

I claim:

1. A method comprising:
receiving wireless service usage information indicating travel speeds of multiple communication devices in a geographical region, a first wireless network providing first wireless services in the geographical region;
receiving a metric indicating second wireless services to provide in the geographical region via a second wireless network; and
based on the travel speeds of the multiple communication devices and the metric, producing a wireless base station installation plan to install the second wireless network.

2. The method as in claim 1, wherein the metric indicates a minimum threshold number of bits to communicate from the second wireless network to a communication device in the geographical region during a communication session.

3. The method as in claim 1, wherein the first wireless network includes first wireless base stations to provide the first wireless services to the multiple communication devices; and
wherein producing the wireless base station installation plan includes:
proposing installation of second wireless base stations in the second wireless network at different locations in the geographical region to support the second wireless services.

4. The method as in claim 1, wherein producing the wireless base station installation plan includes:
based on the travel speeds of the multiple communication devices as indicated by the wireless service usage information, assigning speed values to different segments of a travel path in the geographical region; and
determining a number of new wireless base stations to install in the second wireless network to provide wireless connectivity to the multiple communication devices depending upon the metric and the speed values assigned to the different segments of the travel path.

5. The method as in claim 4, wherein the determined number of new wireless base stations in the second wireless network is configured to provide contiguous wireless coverage to a first communication device traveling through the different segments of the travel path.

6. The method as in claim 5, wherein the speed values include a first speed value and a second speed value;
wherein a first segment of the travel path is assigned the first speed value; and
wherein a second segment of the travel path is assigned the second speed value.

7. The method as in claim 1, wherein the first wireless network is configured to support wireless communications using a first wireless channel; and
wherein the second wireless network is configured to support wireless communications using a second wireless channel.

8. The method as in claim 1, wherein the wireless service usage information is generated by a first wireless network service provider operating the first wireless network in the geographical region, the first wireless network operative to monitor the travel speeds of the multiple communication devices as indicated by the wireless service usage information.

9. The method as in claim 1, wherein the first wireless network supports a first wireless carrier frequency; and
wherein locations of installing wireless base stations in the second wireless network are based on the second wireless network implementing a second wireless carrier frequency, the second wireless channel being greater in magnitude than the first wireless carrier frequency.

10. The method as in claim 1, wherein producing the wireless base station installation plan includes:
via the wireless base station installation plan, proposing installation of a sequence of new wireless base stations in the second wireless network, the proposed sequence of the new wireless base stations operative to provide the second wireless services as continuous wireless services in accordance with the metric.

11. A system comprising:
communication management hardware operative to:
receive wireless service usage information indicating travel speeds of multiple communication devices in a geographical region, a first wireless network providing first wireless services in the geographical region;
receive a metric indicating second wireless services to provide in the geographical region via a second wireless network; and
based on the travel speeds of the multiple communication devices and the metric, produce a wireless base station installation plan to install the second wireless network.

12. The system as in claim 11, wherein the metric indicates a minimum threshold number of bits to communicate from the second wireless network to a communication device in the geographical region during a communication session.

13. The system as in claim 11, wherein the first wireless network includes first wireless base stations to provide the first wireless services to the multiple communication devices; and
wherein the communication management hardware is further operative to propose installation of second wireless base stations in the second wireless network at different locations in the geographical region to support the second wireless services.

14. The system as in claim 11, wherein the communication management hardware is further operative to:
based on the travel speeds of the multiple communication devices as indicated by the wireless service usage information, assign speed values to different segments of a travel path in the geographical region; and
determine a number of new wireless base stations to install in the second wireless network to provide wireless connectivity to the multiple communication devices depending upon the metric and the speed values assigned to the different segments of the travel path.

15. The system as in claim 14, wherein the determined number of new wireless base stations in the second wireless network is configured to provide contiguous wireless coverage to a first communication device traveling through the different segments of the travel path.

16. The system as in claim 15, wherein the speed values include a first speed value and a second speed value;
wherein a first segment of the travel path is assigned the first speed value; and
wherein a second segment of the travel path is assigned the second speed value.

17. The system as in claim 11, wherein the first wireless network is configured to support wireless communications using a first wireless channel; and
wherein the second wireless network is configured to support wireless communications using a second wireless channel.

18. The system as in claim 11, wherein the wireless service usage information is generated by a first wireless network service provider operating the first wireless network in the geographical region, the first wireless network operative to monitor the travel speeds of the multiple communication devices as indicated by the wireless service usage information.

19. The system as in claim 11, wherein the first wireless network supports a first wireless carrier frequency; and
wherein locations of installing wireless base stations in the second wireless network are based on the second wireless network implementing a second wireless carrier frequency, the second wireless channel being greater in magnitude than the first wireless carrier frequency.

20. The system as in claim 11, wherein the communication management hardware is further operative to:
via the wireless base station installation plan, propose installation of a sequence of new wireless base stations in the second wireless network, the proposed sequence of the new wireless base stations operative to provide the second wireless services as continuous wireless services in accordance with the metric.

21. Computer-readable storage hardware having instructions stored thereon, the instructions, when carried out by computer processor hardware, cause the computer processor hardware to:
receive wireless service usage information indicating travel speeds of multiple communication devices in a geographical region, a first wireless network providing first wireless services in the geographical region;
receive a metric indicating second wireless services to provide in the geographical region via a second wireless network; and
based on the travel speeds of the multiple communication devices and the metric, produce a wireless base station installation plan to install the second wireless network.
